(19) United States
(12) Patent Application Publication
(10) Pub. No.: US 2026/0351672 A1
(43) Pub. Date: Nov. 5, 2026

(54) Oxidation-Resistant and High-Temperature-Resistant Electrolyte Additive, Electrolyte and Secondary Battery

(71) Applicant: Huizhou Liwinon New Energy Technology Co., Ltd., Huizhou, Guangdong (CN)

(72) Inventors: Jie Chen, Huizhou, Guangdong (CN); Jianglan Li, Huizhou, Guangdong (CN); Shengben Wu, Huizhou, Guangdong (CN)

(21) Appl. No.: 19/102,485

(22) PCT Filed: Jun. 29, 2023
(86) PCT No.: PCT/CN2023/103969

§ 371 Date: Feb. 10, 2025

(30) Foreign Application Priority Data
Aug. 11, 2022 (CN) 202210961138.2

(51) Int. Cl. H01M 10/0567; H01M 10/0569

(52) U.S. Cl. CPC H01M 10/0567; H01M 10/0569; H01M 2300/0042

(57) ABSTRACT

An oxidation-resistant and high-temperature-resistant electrolyte solution additive, an electrolyte solution and a secondary battery. The electrolyte solution additive comprises a first additive of a formula I and a second additive of a formula II. The structural formula of formula I is: formula I, wherein R₁-R₄ are each independently selected from one of or a combination of several of a linear or cyclic alkyl or alkoxy, a linear or cyclic alkenyl or alkenyloxy, a linear or cyclic alkynyl or alkynyloxy, a halogeno, an aryl, hydrogen, a silyl, and a siloxy, and the sum of the numbers of carbon-carbon double bonds and/or triple bonds in R₁-R₄ is greater than or equal to 2. The structural formula of formula II is: formula II, wherein R₅-R₆ are each independently selected from one or more of a linear or cyclic alkyl or alkoxy, a linear or cyclic alkenyl or alkenyloxy, a linear or cyclic alkynyl or alkynyloxy, a halogeno, an aryl, hydrogen, a silyl and a siloxy.

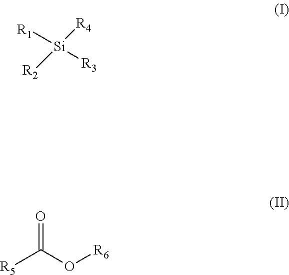

### CROSS-REFERENCE TO RELATED APPLICATIONS

This application is the United States national phase of International Patent Application No. PCT/CN2023/103969 filed Jun. 29, 2023, and claims priority to Chinese Patent Application No. 202210961138.2 filed Aug. 11, 2022, the disclosures of each of which are hereby incorporated by reference in their entireties.

### BACKGROUND

### Technical Field

The present disclosure belongs to the technical field of secondary batteries, and relates to an oxidation-resistant and high-temperature-resistant electrolyte additive, an electrolyte and a secondary battery.

### TECHNICAL CONSIDERATIONS

Lithium-ion batteries are widely used in the fields including smart wearables, computers, smart phones, and electric vehicles, due to their high energy density, long cycle life, high operating voltage, and low self-discharge rate. Regardless of the application field, with the advancement of science and technology, there are higher requirements for lithium-ion battery technology, so as to extend the life of lithium-ion batteries and improve the safety performance of the batteries.

However, an electrolyte solution is easily oxidized under high temperature conditions, causing the rupture of the interface film of the electrode sheet and side reactions, thus affecting the performance of the batteries.

### SUMMARY

In view of the shortcomings of the existing technology, an object of the present disclosure is to provide an oxidation-resistant and high-temperature-resistant electrolyte additive, which is capable of withstanding high temperature conditions, preventing the battery from oxidation and/or side reactions under high-temperature conditions, and thus ensuring the battery quality and/or safety performance.

In order to achieve the above object, the present disclosure adopts the following technical solutions:
an oxidation-resistant and high-temperature-resistant electrolyte additive, comprising a first additive having Formula I and a second additive having Formula II,
wherein a structural formula of Formula I is:

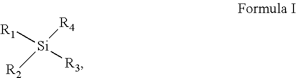

where R₁-R₄ are each independently one or a combination of more selected from the group consisting of a linear or cyclic alkyl or alkoxy, a linear or cyclic alkenyl or alkenyloxy, a linear or cyclic alkynyl or alkynyloxy, a halogen, an aryl, hydrogen, a silyl, and a siloxy, and the total number of carbon-carbon double bond and/or triple bond in R₁-R₄ is greater than or equal to 2; and wherein a structural formula of Formula II is:

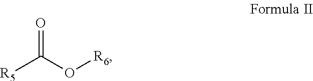

where R₅-R₆ are each independently one or a combination of more selected from the group consisting of a linear or cyclic alkyl or alkoxy, a linear or cyclic alkenyl or alkenyloxy, a linear or cyclic alkynyl or alkynyloxy, a halogen, an aryl, hydrogen, a silyl, and a siloxy.

Preferably, and in some non-limiting embodiments, the structural formula of Formula I may comprise one or a combination of:

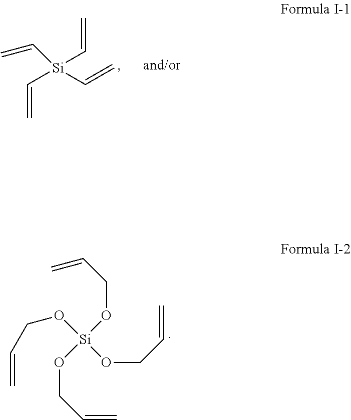

Preferably, and in some non-limiting embodiments, a molecular formula of Formula II is CₘHₙO₂Xₚ, where X is a halogen element, the value of m is 2 to 18, p≥1, 2m=n+p−2*q, and q is any positive integer.

Preferably, and in some non-limiting embodiments, the structural formula of Formula II may comprise one or a combination of:

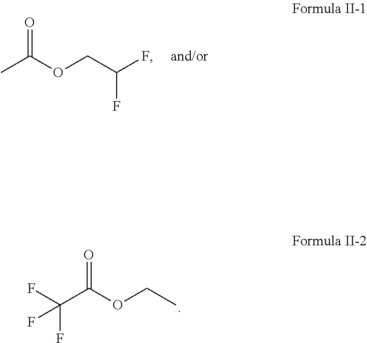

In view of the shortcomings of the existing technology, another object of the present disclosure is to provide an electrolyte, which has high temperature performance, and can prevent the electrode sheet from oxidation reaction at high temperature, thus improving the quality and/or safety performance.

In order to achieve the above object, the present disclosure adopts the following technical solutions:
an electrolyte, comprising the oxidation-resistant and high-temperature-resistant electrolyte additive described above.

Preferably, and in some non-limiting embodiments, the first additive may comprise 0.1 wt %-5 wt % of the total mass of the electrolyte.

Preferably, and in some non-limiting embodiments, the second additive may comprise 3 wt %-40 wt % of the total mass of the electrolyte.

Preferably, and in some non-limiting embodiments, the electrolyte may further comprise an organic solvent and a lithium salt, wherein the organic solvent may comprise 50 wt %-90 wt % of the total mass of the electrolyte, and the lithium salt may comprise 8 wt %-20 wt % of the total mass of the electrolyte.

Preferably, and in some non-limiting embodiments, the electrolyte may further comprise a third additive, and the third additive may comprise 0.5 wt %-20 wt % of the total mass of the electrolyte.

In view of the shortcomings of the existing technology, still another object of the present disclosure is to provide a secondary battery which has good high-temperature performance, oxidation-resistant property, and/or cycle stability.

In order to achieve the above object, the present disclosure adopts the following technical solutions:
a secondary battery comprising the electrolyte described above.

Compared with the existing technology, the beneficial effects of the present disclosure lie in that an oxidation-resistant and high-temperature-resistant electrolyte additive according to the present disclosure is capable of withstanding high temperature conditions, preventing the battery from oxidation and side reactions under high-temperature conditions, and thus ensuring the battery quality and/or safety performance.

### BRIEF DESCRIPTION OF THE DRAWING

FIG. 1 is a schematic structural diagram of a secondary battery according to the principles of the present disclosure.

Reference signs are explained as follows: positive electrode sheet 1, separator 2, negative electrode sheet 3, shell 4, and electrolyte 5.

### DETAILED DESCRIPTION

The present disclosure will be further described in detail below with reference to specific embodiments. However, it is understood that the embodiments of the present disclosure are not limited by the following specific embodiments.

1. An oxidation-resistant and high-temperature-resistant electrolyte additive, comprising a first additive having Formula I and a second additive having Formula II,
wherein a structural formula of Formula I is:

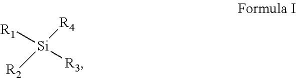

where R₁-R₄ are each independently one or a combination of more selected from the group consisting of a linear or cyclic alkyl or alkoxy, a linear or cyclic alkenyl or alkenyloxy, a linear or cyclic alkynyl or alkynyloxy, a halogen, an aryl, hydrogen, a silyl, and a siloxy, and the total number of carbon-carbon double bond(s) and/or triple bond(s) in R₁-R₄ is greater than or equal to 2; and
wherein a structural formula of Formula II is:

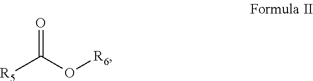

where R₅-R₆ are each independently one or a combination of more selected from the group consisting of a linear or cyclic alkyl or alkoxy, a linear or cyclic alkenyl or alkenyloxy, a linear or cyclic alkynyl or alkynyloxy, a halogen, an aryl, hydrogen, a silyl, and a siloxy.

The oxidation-resistant and high-temperature-resistant electrolyte additive according to the present disclosure is capable of withstanding high temperature conditions, preventing the battery from oxidation and side reactions under high-temperature conditions, and thus ensuring the battery quality and/or safety performance. The first additive having Formula I described in the present disclosure has a carbon-carbon unsaturated bond, which can be reduced to generate Solid Electrolyte Interphase (SEI) on the surface of the negative electrode. The silane structure itself has good stability, which can improve the stability of the generated SEI, protect the negative electrode, and/or reduce the side reactions of the negative electrode with the electrolyte. Meanwhile, the second additive having Formula II is a halogenated solvent, which has decreased hydrogen oxidation activity and is more resistant to oxidation compared with conventional solvents, and thus can reduce the side reactions between the positive electrode and the solvent of the electrolyte. These two types of compounds can produce a synergistic effect in protecting the positive and negative electrodes and improve the cycle, safety and/or stability of the battery. The halogenated second additive has better oxidation resistance and/or can reduce the side reactions between the positive electrode and the electrolyte.

In some non-limiting embodiments, the structural formula of Formula I may comprise one or a combination of:

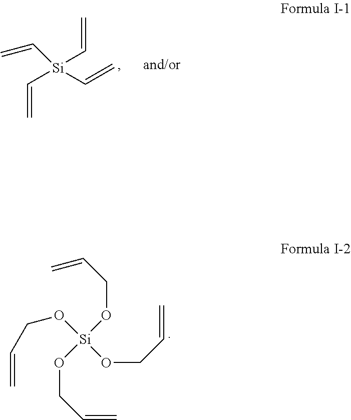

In some non-limiting embodiments, the molecular formula of Formula II is CₘHₙO₂Xₚ, where X is a halogen element, the value of m is 2 to 18, p≥1, 2m=n+p−2*q, and q is any positive integer.

In some non-limiting embodiments, the structural formula of Formula II may comprise one or a combination of:

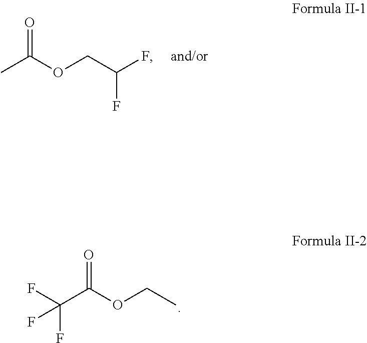

2. An electrolyte, which has high temperature performance, and can prevent the electrode sheet from oxidation reaction at high temperature, thus improving the quality and/or safety performance.

An electrolyte comprising the oxidation-resistant and high-temperature-resistant electrolyte additive described above.

In some non-limiting embodiments, the first additive may account for 0.1 wt %-5 wt % of the total mass of the electrolyte. The first additive may account for 0.1 wt %-1.5 wt %, 1.5 wt %-2.5 wt %, 2.5 wt %-3.5 wt %, 3.5 wt %-4.5 wt %, or 4.5 wt %-5 wt % of the total mass of the electrolyte, or the first additive may account for 0.1 wt %, 0.8 wt %, 1.2 wt %, 2.8 wt %, 3 wt %, 3.5 wt %, 4 wt %, 4.5 wt %, or 5 wt % of the total mass of the electrolyte.

In some non-limiting embodiments, the second additive may account for 3 wt %-40 wt % of the total mass of the electrolyte. Preferably, and in non-limiting embodiments, the second additive may account for 3 wt %-10 wt %, 10 wt %-20 wt %, 20 wt %-30 wt %, or 30 wt %-40 wt % of the total mass of the electrolyte, or the second additive may account for 3 wt %, 8 wt %, 12 wt %, 18 wt %, 20 wt %, 25 wt %, 27 wt %, 30 wt %, 34 wt %, 36 wt %, 38 wt %, or 40 wt % of the total mass of the electrolyte.

In some non-limiting embodiments, the electrolyte may further comprise an organic solvent and a lithium salt, wherein the organic solvent may account for 50 wt %-90 wt % of the total mass of the electrolyte, and the lithium salt may account for 8 wt %-20 wt % of the total mass of the electrolyte. The organic solvent may account for 50 wt %-60 wt %, 60 wt %-70 wt %, 70 wt %-80 wt %, or 80 wt %-90 wt % of the total mass of the electrolyte, or the organic solvent may account for 50 wt %, 55 wt %, 58 wt %, 60 wt %, 62 wt %, 65 wt %, 68 wt %, 70 wt %, 75 wt %, 78 wt %, 82 wt %, 85 wt %, or 90 wt % of the total mass of the electrolyte. The lithium salt may account for 8 wt %-12 wt %, 12 wt %-18 wt %, or 18 wt %-20 wt % of the total mass of the electrolyte, or the lithium salt may account for 8 wt %, 10 wt %, 12 wt %, 15 wt %, 16 wt %, 18 wt %, or 20 wt % of the total mass of the electrolyte.

In some non-limiting embodiments, the electrolyte may further comprise a third additive, and the third additive may account for 0.5 wt %-20 wt % of the total mass of the electrolyte. Preferably, and in some non-limiting embodiments, the third additive may account for 0.5 wt %-8 wt %, 8 wt %-15 wt %, or 15 wt %-20 wt % of the total mass of the electrolyte, or the third additive may account for 0.5 wt %, 0.8 wt %, 1.2 wt %, 1.5 wt %, 2 wt %, 3 wt %, 5 wt %, 8 wt %, 10 wt %, 13 wt %, 15 wt %, or 20 wt % of the total mass of the electrolyte. 3. A secondary battery, which has good high-temperature performance, oxidation-resistant property, and/or cycle stability.

A secondary battery, comprising the electrolyte described above.

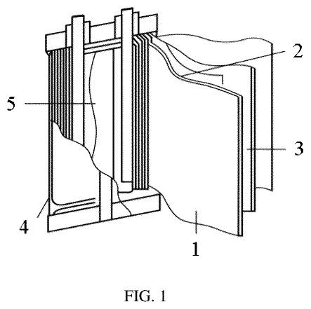

As shown in FIG. 1, a secondary battery comprises a positive electrode sheet (1), a separator (2), a negative electrode sheet (3), a shell (4) and the electrolyte (5) described above; the separator (2) is provided to separate the positive electrode sheet (1) and the negative electrode sheet (3), and the shell (4) is provided to encapsulate the positive electrode sheet (1), the separator (2), the negative electrode sheet (3), and the electrolyte (5).

### Positive Electrode

The positive electrode sheet may comprise a positive electrode current collector and a positive electrode active material layer provided on at least one side of the positive electrode current collector. The positive electrode active material layer may comprise a positive electrode active material, and the positive electrode active material may comprise but is not limited to one of or a combination of compounds represented by the chemical formula LiₐNiₓCo_{y}M_{z}O_{2-b}N_{b}, where 0.95≤a≤1.2, x>0, y≥0, z≥0, and x+y+z=1, 0≤b≤1, M is selected from one of or a combination of Mn and/or Al, and N is selected from one or a combination of F, P, and/or S. The positive electrode active material may comprise but not be limited to one of or a combination of LiCoO₂, LiNiO₂, LiVO₂, LiCrO₂, LiMn₂O₄, LiCoMnO₄, Li₂NiMn₃O₈, LiNi_{0.5}Mn_{1.5}O₄, LiCoPO₄, LiMnPO₄, LiFePO₄, LiNiPO₄, LiCoFSO₄, CuS₂, FeS₂, MoS₂, NiS, TiS₂, and/or the like. The positive electrode active material may be modified. The method of modifying the positive electrode active material should be known to those skilled in the art. For example, the positive electrode active material may be modified by coating, doping, etc. The material used for the modification may comprise but not be limited to one of or a combination of Al, B, P, Zr, Si, Ti, Ge, Sn, Mg, Ce, W, etc. Typically, the positive electrode current collector may be a structure or a component that collects current. The positive electrode current collector may be made of various materials suitable for use as a positive electrode current collector for lithium-ion batteries in the art. For example, the positive electrode current collector may comprise but not be limited to metal foils, etc., and preferably may comprise but not be limited to an aluminum foil, etc. The positive electrode active material layer may further comprise a binder and a conductive agent, and the binder may be polyvinylidene fluoride (PVDF).

### Negative Electrode

The negative electrode sheet may comprise a negative electrode current collector and a negative electrode active material layer provided on at least one side of the negative electrode current collector. The negative electrode active material layer may comprise a negative electrode active material. The negative electrode active material may comprise but not be limited to one or more of graphite, soft carbon, hard carbon, carbon fiber, a mesophase carbon microsphere, a silicon-based material, a tin-based material, lithium titanate and/or other metals that can form an alloy with lithium. The graphite may be selected from one or more of artificial graphite, natural graphite and/or modified graphite. The silicon-based material may be selected from one or more of elemental silicon, silicon oxide compounds, silicon carbon composites, and/or silicon alloys. The tin-based material may be selected from one or more of elemental tin, tin oxide compounds, and/or tin alloys. Typically, the negative electrode current collector may be a structure or a component that collects current. The negative electrode current collector may be made of various materials suitable for use as a negative electrode current collector for lithium-ion batteries in the art. For example, the negative electrode current collector may comprise but not be limited to metal foil, etc., and preferably may comprise but not be limited to a copper foil, etc. The negative active material layer may further comprise a binder and a conductive agent, and the binder may be polyvinylidene fluoride (PVDF).

### Separator

The separator may be made from various materials suitable for use as a lithium-ion battery separator in the art. For example, it may be made of one or a combination of materials comprising but not limited to polyethylene, polypropylene, polyvinylidene fluoride, aramid, polyethylene terephthalate, polytetrafluoroethylene, polyacrylonitrile, polyimide, polyamide, polyester, and/or natural fiber.

The material of the shell may be one of aluminum-plastic film and/or stainless steel.

### Example 1

1. Preparation of an electrolyte: In a glove box filled with argon (moisture content <5 ppm, oxygen content <5 ppm), ethylene carbonate (EC), propylene carbonate (PC), ethyl methyl carbonate (EMC), propyl propionate (PP), and ethyl propionate (EP) were mixed in a mass ratio of 1:1:1:1:1 to obtain an organic solvent. The organic solvent was mixed with lithium hexafluorophosphate so that the weight percentage of lithium salt in the electrolyte was 13.70%, to obtain a mixture of the organic solvent and lithium hexafluorophosphate. To the mixture, the compounds of Formula I-1 and Formula II-1 according to the present disclosure (the compound of Formula I-1 accounted for 0.5 wt % of the total mass of the electrolyte, and the compound of Formula II-1 accounted for 20 wt % of the total mass of the electrolyte), and 3 wt % 1,3-propane sultone, 3 wt % fluoroethylene carbonate, and 3 wt % 1,3,6-hexanetricarbonitrile were added and mixed evenly to obtain the electrolyte.

2. Preparation of a positive electrode sheet: NCM811 as a positive electrode active material, superconducting carbon and carbon tube as conductive agents, and polyvinylidene fluoride (relative molecular mass of 1,200,000) as a binder were mixed evenly in a mass ratio of 96:2.0:0.5:1.5 to prepare a positive electrode slurry. The positive electrode slurry was coated on one surface of an aluminum foil as a current collector, the aluminum foil was dried and rolled up at 85 °C, and then the positive electrode slurry was coated and dried on the other side of the aluminum foil following the above process. Then, the prepared electrode sheet of aluminum foil coated with positive electrode active material layers on both sides was cold pressed, then trimmed, cut, and slit, to prepare the positive electrode sheet.

3. Preparation of a negative electrode sheet: A silicon-carbon negative electrode active material, superconducting carbon as a conductive agent, and polyvinylidene fluoride (relative molecular mass of 1,600,000) as a binder were made into a negative electrode slurry in a mass ratio of 96.5:1.0:2.5. The negative electrode slurry was coated on a copper foil as a current collector, the copper foil was dried and rolled up at 85 °C, and then the negative electrode slurry was coated and dried on the other side of the copper foil following the above process. Then, the prepared electrode sheet of copper foil coated with negative electrode active material layers on both sides was cold pressed, then trimmed, cut, and slit, to prepare the negative electrode sheet.

4. Separator: A polyethylene porous film with a thickness of 16 m was used as a separator.

5. Preparation of a battery: The above positive electrode sheet, separator and negative electrode sheet were wound into a battery core with a capacity of about 5 Ah. The separator was located between the adjacent positive electrode sheet and negative electrode sheet. A positive electrode was led out by spot welding aluminum tabs, and a negative electrode was led out by spot welding nickel tabs. Then, the battery core was placed in an aluminum-plastic packaging bag, baked and injected with the above electrolyte. After encapsulation, formation, volume separation and other processes, a lithium-ion battery was finally prepared.

The preparation of the batteries of Examples 2 to 12 and Comparative Examples 1 to 5 were carried out with reference to the methods in Example 1. The specific components and contents in Examples 1 to 12 and Comparative Examples 1 to 5 were shown in Table 1.

TABLE 1
The ratios of components of the electrolytes of
Examples 1 to 12 and Comparative Examples 1 to 5

| | Compounds of | | Compounds of | | Conventional additives (wt %) | | |
|---|---|---|---|---|---|---|---|
| | Formula I (wt %) | | Formula II (wt %) | | | | 1,3,6-hexane- |
| No. | I-1 | I-2 | II-1 | II-2 | PS | FEC | tricarbonitrile |
| Example 1 | 0.5 | \ | 20 | \ | 3 | 3 | 3 |
| Example 2 | 1 | \ | 20 | \ | 3 | 3 | 3 |
| Example 3 | 2 | \ | 20 | \ | 3 | 3 | 3 |
| Example 4 | \ | 0.5 | \ | 20 | 3 | 3 | 3 |
| Example 5 | \ | 1 | \ | 20 | 3 | 3 | 3 |
| Example 6 | \ | 2 | \ | 20 | 3 | 3 | 3 |
| Example 7 | 0.5 | 2 | 20 | \ | 3 | 3 | 3 |
| Example 8 | 2 | 0.5 | 20 | \ | 3 | 3 | 3 |
| Example 9 | 0.5 | 2 | \ | 20 | 3 | 3 | 3 |
| Example 10 | 2 | 0.5 | \ | 20 | 3 | 3 | 3 |
| Example 11 | 1 | 1 | 10 | 10 | 3 | 3 | 3 |
| Example 12 | 2 | 2 | 20 | 20 | 3 | 3 | 3 |
| Comparative | \ | \ | \ | \ | 3 | 3 | 3 |
| Example1 | | | | | | | |
| Comparative | 0.5 | \ | \ | \ | 3 | 3 | 3 |
| Example 2 | | | | | | | |
| Comparative | \ | 0.5 | \ | \ | 3 | 3 | 3 |
| Example 3 | | | | | | | |
| Comparative | \ | \ | 20 | \ | 3 | 3 | 3 |
| Example 4 | | | | | | | |
| Comparative | \ | \ | \ | 20 | 3 | 3 | 3 |
| Example 5 | | | | | | | |

The following tests were performed on the lithium-ion batteries of Examples 1 to 12 and Comparative Examples 1 to 5 respectively.

### 1. Cycle Performance Test of Lithium-Ion Batteries

The lithium-ion batteries were placed in a constant temperature chamber at 45 °C and left to stand for 30 minutes to allow the lithium-ion batteries to reach a constant temperature. The lithium-ion batteries that reached the constant temperature were charged at a constant current of 0.5 C to a voltage of 4.4 V, then charged at a constant voltage of 4.4 V to a current of 0.05 C, and then discharged at a constant current of 0.5 C to a voltage of 3.0 V. The above steps were taken as a charging and discharging cycle, and the charging and discharging cycles were repeated. The capacity retention ratio of the lithium-ion battery after 500 cycles was calculated.

### 2. Overcharge Test

Three pieces of batteries were placed in an explosion-proof box; the lithium-ion batteries were charged at a constant current of 3.0 C to 4.6 V, and then charged at a constant voltage for 7 hours. It was considered to pass if there was no fire or explosion.

### 3. Short Circuit Test

The lithium-ion battery was charged to 4.4 V at a constant current of 0.5 C, and then charged at a constant voltage to a current of 0.05 C until the battery was fully charged. Three pieces of batteries were placed into an explosion-proof thermostat, and the positive and negative electrodes of the batteries were short-circuited with an 80 mΩ resistance wire for 24 hours. It was considered to pass if there was no fire or explosion.

The results of the performance tests of the lithium-ion batteries of Examples 1 to 12 and Comparative Examples 1 to 2 were shown in Table 2.

TABLE 2
The results of the performance
tests of lithium-ion batteries and electrolytes

| | Retention ratio | | |
|---|---|---|---|
| | (%) after 500 | Over- | Short |
| | cycles at | charge | circuit |
| No. | 45 °C | test | test |
| Example 1 | 65.3 | 3/3 passed | 2/3 passed |
| Example 2 | 67.8 | 3/3 passed | 3/3 passed |
| Example 3 | 69.0 | 3/3 passed | 3/3 passed |
| Example 4 | 63.2 | 3/3 passed | 0/3 passed |
| Example 5 | 64.5 | 3/3 passed | 0/3 passed |
| Example 6 | 65.3 | 3/3 passed | 2/3 passed |
| Example 7 | 70.4 | 3/3 passed | 3/3 passed |
| Example 8 | 73.2 | 3/3 passed | 3/3 passed |
| Example 9 | 68.3 | 3/3 passed | 3/3 passed |
| Example 10 | 71.7 | 3/3 passed | 3/3 passed |
| Example 11 | 67.5 | 3/3 passed | 3/3 passed |
| Example 12 | 78.7 | 3/3 passed | 3/3 passed |
| Comparative Example 1 | 50.8 | 0/3 passed | 0/3 passed |
| Comparative Example 2 | 58.2 | 3/3 passed | 0/3 passed |
| Comparative Example 3 | 56.5 | 3/3 passed | 0/3 passed |
| Comparative Example 4 | 60.5 | 0/3 passed | 0/3 passed |
| Comparative Example 5 | 57.8 | 0/3 passed | 0/3 passed |

As shown in the above Table 1 and Table 2, the secondary batteries prepared with the electrolyte additive of the present disclosure had better performance. After 500 cycles at 45 °C, the capacity retention ratio was up to 78.7%. All the batteries passed the overcharge test, and 80.56% of the batteries passed the short circuit test, indicating good battery performance. The batteries could withstand high temperature conditions, prevent the battery from oxidation and side reactions under high-temperature conditions, and ensure the battery quality and safety performance. In contrast, the capacity retention ratio of the Comparative Examples 1 to 5 after 500 cycles at 45 °C was only 60.5%, the pass rate of overcharge test was only 40%, and the pass rate of short circuit was 0, which indicated serious safety problems.

By comparison of Examples 1 to 3, it was showed that, when a first additive of Formula I-1 and a second additive of Formula II-1 were used, the performance was better as the usage amount of the first additive increased. By comparison of Examples 4 to 6, it was showed that, when a first additive of Formula I-2 and a second additive of Formula II-2 were used, the performance was better as the usage amount of the first additive increased. By comparison of Examples 7 and 8, it was showed that, when the first additive and the second additive were used in combination and the first additives of both Formula I-1 and Formula I-2 (in a weight ratio of 2:0.5) were used, the prepared secondary battery had better performance, and the capacity retention ratio was 73.2% after 500 cycles at 45 °C, which was 2.8% higher than that of Example 7 (70.4%), indicating that the first additive of Formula I-1 contributed better to capacity retention performance than the first additive of Formula I-2. By comparison of Examples 7 to 10, it was showed that, when the first additives of both Formula I-1 and Formula I-2 were used in combination with the second additive, the first additives of both Formula I-1 and Formula I-2 were more synergistic with the second additive of Formula II-1, and the prepared secondary battery had a higher capacity retention ratio after 500 cycles at 45 °C. By comparison of Examples 11 and 12, it was showed that, when the first additives of both Formula I-1 and Formula I-2 were used in combination with the second additives of both Formula II-1 and Formula II-2, the efficiency of the prepared secondary battery was better than that of the secondary battery prepared by using one additive alone, or using two first additives and one second additive, or using one first additive and two second additives, and the performance reached the optimal value, of which the capacity retention ratio after 500 cycles at 45 °C was 78.7%, and all the batteries passed both the overcharge test and the short circuit test, and the performance was better when the additives of Formula I-1 and Formula II-2 were used in combination. By comparison of Examples 4 to 6, it was showed that, when the compounds of Formula I-2 and Formula II-2 were used, the usage amount of the compound of Formula I-2 was 2 wt % and the usage amount of the compound of Formula II-2 was 20 wt %, the prepared secondary battery had good capacity retention ratio, good overcharge performance and good short-circuit protection performance.

Based on the disclosure and teaching of the foregoing specification, those skilled in the art can make changes and modifications to the above non-limiting embodiments. Therefore, the present disclosure is not limited to the aforesaid specific embodiments. Any obvious improvements, substitutions or modifications made by those skilled in the art on the basis of the present disclosure fall within the protection scope of the present disclosure. In addition, although some specific terms are used in this specification, these terms are only for convenience of explanation and do not constitute any limitation on the present disclosure.

1. An oxidation-resistant and high-temperature-resistant electrolyte additive, comprising a first additive having Formula I and a second additive having Formula II,
wherein a structural formula of Formula I is: 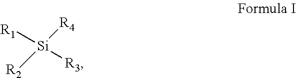
where R₁-R₄ are each independently one or more selected from the group consisting of a linear or cyclic alkyl, a linear or cyclic alkoxy, a linear or cyclic alkenyl, a linear or cyclic alkenyloxy, a linear or cyclic alkynyl, a linear or cyclic alkynyloxy, a halogen, an aryl, hydrogen, a silyl, and a siloxy, and a total number of carbon-carbon double bond and/or triple bond in R₁-R₄ is greater than or equal to 2; and
wherein, a structural formula of Formula II is: 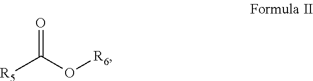
where R₅-R₆ are each independently one or more selected from the group consisting of a linear or cyclic alkyl, a linear or cyclic alkoxy, a linear or cyclic alkenyl, a linear or cyclic alkenyloxy, a linear or cyclic alkynyl, a linear or cyclic alkynyloxy, a halogen, an aryl, hydrogen, a silyl, and a siloxy.

2. The oxidation-resistant and high-temperature-resistant electrolyte additive according to claim 1, wherein the structural formula of the Formula I comprises one or a combination of:

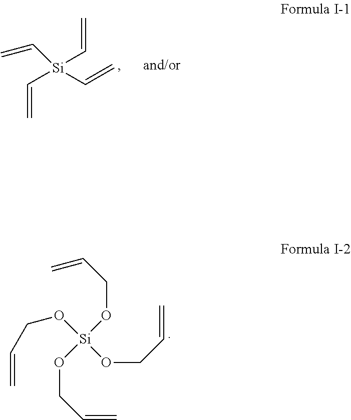

3. The oxidation-resistant and high-temperature-resistant electrolyte additive according to claim 1, wherein a molecular formula of the Formula II is CₘHₙO₂Xₚ, where X is a halogen element, a value of m is 2 to 18, p≥1, 2m=n+p−2*q, and q is any positive integer.

4. The oxidation-resistant and high-temperature-resistant electrolyte additive according to claim 1, wherein the structural formula of the Formula II comprises one or a combination of:

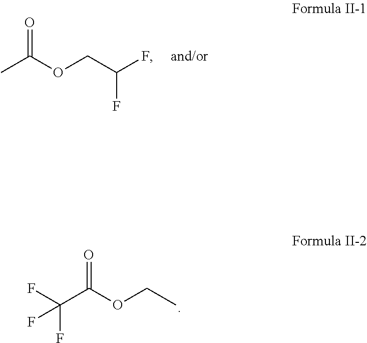

5. An electrolyte: comprising the oxidation-resistant and high-temperature-resistant electrolyte additive of claim 1, and an organic solvent.

6. The electrolyte according to claim 5, wherein the first additive comprises 0.1 wt % to 5 wt % of a total mass of the electrolyte.

7. The electrolyte according to claim 5, wherein the second additive comprises 3 wt % to 40 wt % of a total mass of the electrolyte.

8. The electrolyte according to claim 5, wherein the electrolyte further comprises a lithium salt.

9. The electrolyte according to claim 5, wherein the electrolyte further comprises a third additive.

10. A secondary battery comprising a positive electrode sheet, a separator, a negative electrode sheet, and the electrolyte of claim 5.

11. The electrolyte according to claim 5, wherein the organic solvent comprises 50 wt % to 90 wt % of a total mass of the electrolyte.

12. The electrolyte according to claim 8, wherein the lithium salt comprises 8 wt % to 20 wt % of the total mass of the electrolyte.

13. The electrolyte according to claim 9, wherein the third additive comprises 0.5 wt % to 20 wt % of the total mass of the electrolyte.

14. The secondary battery according to claim 10, wherein the separator is provided to separate the positive electrode sheet and the negative electrode sheet.

15. The secondary battery according to claim 10, wherein the secondary battery further comprises a shell, which is provided to encapsulate the positive electrode sheet, the separator, the negative electrode sheet and the electrolyte.

16. A secondary battery comprising a positive electrode sheet, a separator, a negative electrode sheet, and the electrolyte of claim 6.

17. A secondary battery comprising a positive electrode sheet, a separator, a negative electrode sheet, and the electrolyte of claim 7.

18. A secondary battery comprising a positive electrode sheet, a separator, a negative electrode sheet, and the electrolyte of claim 8.

19. A secondary battery comprising a positive electrode sheet, a separator, a negative electrode sheet, and the electrolyte of claim 9.
